(19) United States
(12) Patent Application Publication
(10) Pub. No.: US 2025/0036875 A1
(43) Pub. Date: Jan. 30, 2025

(54) ELECTRONIC DEVICE FOR CARRYING OUT SCORING FROM USER-CREATED ESSAY AND OPERATION METHOD THEREOF

(71) Applicant: COLLEGENIE.AI CORP., Hanam-si, Gyeonggi-do (KR)

(72) Inventors: Kwang Il KIM, Seoul (KR); Keun Jin KIM, Seoul (KR)

(73) Assignee: COLLEGENIE.AI CORP., Hanam-si, Gyeonggi-do (KR)

(21) Appl. No.: 18/836,887

(22) PCT Filed: Jan. 26, 2023
(86) PCT No.: PCT/KR2023/001204

§ 371 Date: Aug. 8, 2024

(30) Foreign Application Priority Data
Feb. 9, 2022 (KR) 10-2022-0017169

(51) Int. Cl. G06F 40/284; G06F 40/247

(52) U.S. Cl. CPC G06F 40/284; G06F 40/247

(57) ABSTRACT

An electronic device, according to one embodiment of the present disclosure, may comprise: a preprocessing unit which segments an inputted story by word and, according to a word meaning inference possibility, distinguishes first context information and second context information and outputs same; a valid word selection unit which extracts, from the first context information, word information satisfying a predetermined criterion, extracts, among the first context information, word information having a specific linguistic form, and carries out expansion into similar words for the second context information; and a scoring unit which receives output values, of the valid word selection unit, for respective analysis elements of essay text data, calculates the degree of similarity between data being compared and the output values, and thus outputs scoring information of the essay text data.

### TECHNICAL FIELD

The technical idea of the present disclosure relates to an electronic device, and more particularly, to an electronic device for carrying out scoring a user-created essay and an operation method thereof.

### BACKGROUND ART

The conventional college admissions consulting has been providing editing of essays focusing on grammar and vocabulary, but in most cases, failed to evaluate factors that admissions officers pay attention to, such as the essay's theme, relevance to each question, and level of interest to each university.

In particular, in some countries, such as the United States, the need for holistic analysis solutions has increased due to changes in SAT exam policies, and a solution that can provide more professional analysis of essays is needed.

### DISCLOSURE

### Technical Problem

The technical idea of the present disclosure aimed at solving problems is directed to providing a method of scoring an essay created by a user by analyzing words in the essay.

### Technical Solution

An electronic device according to one embodiment of the present disclosure includes a preprocessing unit configured to segment an input story by each word and, according to a word meaning inference possibility, distinguish first context information and second context information and output the distinguished information, a valid word selection unit configured to extract, from the first context information, word information satisfying a predetermined criterion, extract, from the first context information, word information having a specific linguistic form, and carry out analogous word expansion for the second context information, and a scoring unit configured to receive output values of the valid word selection unit for each analysis element of essay text data, and calculate a degree of similarity between data to be compared and the output values to output scoring information of the essay text data.

According to one embodiment, the valid word selection unit may extract adjective word information from the first context information based on a first linguistic form inference model, and extract noun word information based on a second linguistic form inference model which has a higher inference speed but lower accuracy than the first linguistic form inference model.

According to one embodiment, the second linguistic form inference model may generate an original form of a word, compare a word in the input story with the original form of the word, and convert the original form of the word back to an original word.

According to one embodiment, the valid word selection unit may output dictionary-defined word information in the first context information as the word information satisfying the predetermined criterion.

According to one embodiment, the output values may be information obtained by vectorizing, for each of the analysis elements, the word information satisfying the predetermined criterion, the word information having the specific linguistic form, and analogous word expansion result information.

According to one embodiment, the scoring unit may compare distribution of the number of words in the data to be compared and distribution of the output values.

According to one embodiment, the scoring unit may compare distribution of the number of all words in the data to be compared and the output values, or compare distribution of the number of words for each position in the data to be compared and the essay text data.

### Advantageous Effects

According to embodiments of the present disclosure, an electronic device can segment an input story by each word and generate a score of an essay according to the distribution of words satisfying a predetermined criterion, words having a specific linguistic form, and analogous words. At this time, the electronic device can analyze the essay with high reliability by comparing the data to be compared, which is evaluated as an excellent essay, with the essay created by the user.

The effects that can be obtained from the exemplary embodiments of the present disclosure are not limited to the effects mentioned above, and other effects that are not mentioned can be clearly derived and understood by those skilled in the art to which the exemplary embodiments of the present disclosure belong from the following description. That is, unintended effects resulting from implementing the exemplary embodiments of the present disclosure can also be derived by those skilled in the art from the exemplary embodiments of the present disclosure.

### DESCRIPTION OF DRAWINGS

FIG. 1 is a block diagram illustrating a configuration of an electronic device according to an embodiment of the present disclosure.

FIG. 2 is a block diagram illustrating a configuration of a processor according to one embodiment.

FIG. 3 is a block diagram illustrating a configuration of a preprocessing unit according to one embodiment.

FIG. 4 is a diagram illustrating first context information and second context information extracted according to one embodiment.

FIG. 5 is a block diagram illustrating a valid word selection unit and input/output data according to one embodiment.

FIG. 6 is a flowchart illustrating a method of scoring an input story according to one embodiment of the present disclosure.

FIG. 7 is a diagram illustrating vectors generated for each analysis element according to one embodiment.

### BEST MODE FOR CARRYING OUT THE INVENTION

An electronic device that performs a scoring method based on assay text data according to one embodiment of the present invention includes a preprocessing unit configured to segment an input story by each word and, according to a word meaning inference possibility, distinguish first context information and second context information and output the distinguished information, a valid word selection unit configured to extract, from the first context information, word information satisfying a predetermined criterion, extract, from the first context information, word information having a specific linguistic form, and carry out analogous word expansion for the second context information, and a scoring unit configured to receive output values of the valid word selection unit for each analysis element of essay text data, and calculate the degree of similarity between data to be compared and the output values to output scoring information of the essay text data.

### Modes of the Invention

Hereinafter, various embodiments of the present disclosure are described in connection with the accompanying drawings. Various embodiments of the present disclosure may be subject to various modifications and may have various embodiments, and specific embodiments are illustrated in the drawings and the related detailed description is set forth. However, this is not intended to limit the various embodiments of the present disclosure to the specific embodiments, and it should be understood to include all modifications and/or equivalents or substitutes included in the spirit and scope of the various embodiments of the present disclosure. In connection with the description of the drawings, like reference numerals have been used for like components.

The terms “comprise” and “have” used in the embodiments of the present disclosure, specify the presence of stated features, numerals, steps, operations, components, parts, or a combination thereof, but do not preclude the presence or addition of one or more other features, numerals, steps, operations, components, parts, or a combination thereof.

In various embodiments of the present disclosure, the expression “or” or the like includes any and all combinations of the words listed together. For example, “A or B” may include A, may include B, or may include both A and B.

The expressions “first,” “second,” “primary,” or “secondary” used in various embodiments of the present disclosure may modify various components of various embodiments, but do not limit the components. For example, the expressions do not limit the order and/or importance of the components, and may be used to distinguish one component from another.

When a component is referred to as being “coupled” or “connected” to another component, it is understood that not only a direct connection relationship but also an indirect connection relationship through an intermediate component may also be included.

In the embodiments of the present disclosure, terms such as “module,” “unit,” “part,” etc., are terms used to refer to components that perform at least one function or operation, and these components may be implemented as hardware or software, or may be implemented as a combination of hardware and software. In addition, a plurality of “modules,” “units,” “parts,” etc., may be integrated into at least one module or chip and implemented as at least one processor, except in cases where each needs to be implemented as a separate specific hardware.

It will also be understood that those terms such as those defined in commonly used dictionaries should be interpreted as having a meaning consistent with their meaning in the context of the related art and the background of the present disclosure, and will not be construed as having an idealized or excessively formal meaning, unless specifically defined herein otherwise.

In this disclosure, artificial intelligence (AI) may refer to a field that studies artificial intelligence or a methodology for creating the AI, and machine learning may refer to an algorithm that enables a computer to analyze data as a technical method that enables a computing device to perform learning through data to understand a specific object or condition or to find and classify the patterns of data, as a field of artificial intelligence technology. The machine learning disclosed in the present invention may be understood as a meaning that includes an operation method of training an artificial intelligence model.

Hereinafter, various embodiments of the present disclosure will be described in detail with reference to the accompanying drawings.

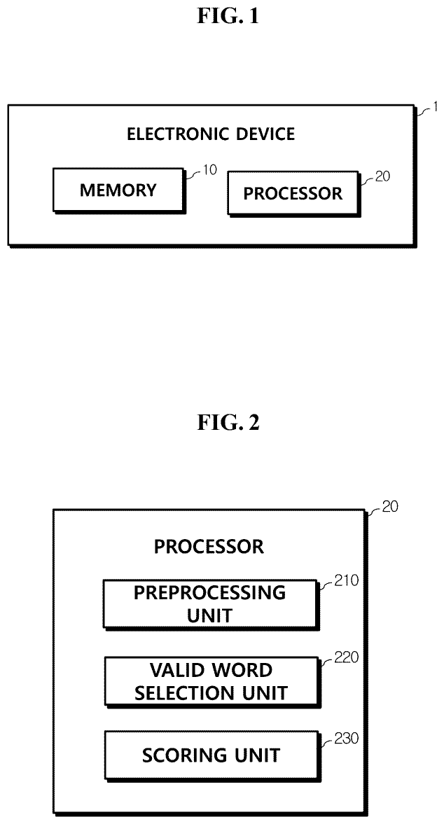

FIG. 1 is a block diagram illustrating a configuration of an electronic device according to an embodiment of the present disclosure.

Referring to FIG. 1, an electronic device 1 may include a memory 10 and a processor 20.

The electronic device 1 may be implemented as a server including at least one computer. In this case, the electronic device 1 may communicate with external devices through various communication methods. Specifically, the electronic device 1 may be connected to various users' terminal devices through at least one application or web page and perform a control method according to various embodiments, which will be described below.

In addition, the electronic device 1 may correspond to any of various terminal devices such as a smartphone, a tablet PC, a laptop PC, a desktop PC, a personal digital assistant (PDA), and a wearable device.

The memory 10 is a component that stores at least one instruction or data related to an operating system (OS) for controlling the overall operation of the components of the electronic device 1 and the components of the electronic device 1.

The memory 10 may include a non-volatile memory, such as a read-only memory (ROM) or a flash memory, and may include a volatile memory, such as a dynamic random access memory (DRAM). In addition, the memory 20 may include a hard disk, a solid state drive (SSD), etc.

The memory 10 may include one or more artificial intelligence models used in various embodiments that will be described below, and this artificial intelligence model may be a model trained through supervised learning, unsupervised learning, reinforcement learning, etc. The artificial intelligence model may correspond to a neural network model that is trained in a way that is updated according to the weights between nodes included in different layers.

The processor 20 is a component for controlling the overall configuration and operation of the electronic device 1.

The processor 20 may be connected to the memory 10 and control the electronic device 1 by executing the at least one instruction stored in the memory 10.

To this end, the processor 20 may be implemented as a general-purpose processor such as a central processing unit (CPU) or an application processor (AP), a graphic-specific processor such as a graphic processing unit (GPU) or a vision processing unit (VPU), or an artificial intelligence-specific processor such as a neural processing unit (NPU). The processor 20 may include a volatile memory such as a static random access memory (SRAM).

Meanwhile, although not shown, the electronic device 1 may further include a communication unit for communication with at least one external device.

The communication unit may be connected to external servers and/or terminal devices through one or more networks, and at this time, transmit or receive data with each other through various wired and wireless communication methods.

The network may be a personal area network (PAN), a local area network (LAN), or a wide area network (WAN) depending on the area or size of the network, and may be an Intranet, an Extranet, or the Internet depending on the openness of the network.

Wireless communication may include at least one of communication methods such as long-term evolution (LTE), LTE Advance (LTE-A), 5th Generation (5G) mobile communications, code division multiple access (CDMA), wideband CDMA (WCDMA), a universal mobile telecommunications system (UMTS), a wireless broadband (WiBro), a global system for mobile communications (GSM), time division multiple access (DMA), Wi-Fi, Wi-Fi Direct, Bluetooth, near field communication (NFC), ZigBee, etc.

Wired communication may include at least one of communication methods such as Ethernet, an optical network, a universal serial bus (USB), Thunderbolt, etc.

Meanwhile, the communication methods are not limited to the examples described above and may include newly emerging communication methods as technology develops.

The electronic device 1 may acquire essay text data according to a user input and output scoring information by analyzing the essay text data.

The user input may be received through a user input unit (e.g., a touch screen, a button, a microphone, a camera {motion recognition unit}) included in the electronic device 1. In addition, when the electronic device 1 is a server, the user input may be received through at least one terminal device connected to the electronic device 1.

FIG. 2 is a block diagram illustrating a configuration of a processor according to one embodiment.

Referring to FIG. 2, the processor 20 may include a preprocessing unit 210, a valid word selection unit 220, and a scoring unit 230. In addition, although the preprocessing unit 210, the valid word selection unit 220, and the scoring unit 230 may each be configured as separate hardware components, the preprocessing unit 210, the valid word selection unit 220, and the scoring unit 230 of the present disclosure are not limited to this, and may be configured as separate software components on a single hardware component.

The preprocessing unit 210 may segment an input story by each word for the purpose of word analysis, distinguish first context information and second context information, and output the distinguished information. The valid word selection unit 220 may output data analyzed for the first context information and the second context information. The scoring unit 230 may output scoring information of the essay text data by calculating the degree of similarity between an output value output from the valid word selection unit 220 and data to be compared.

The first context information and the second context information are distinguished based on whether the word meanings can be inferred. The first context information may be composed of words whose meanings can be inferred, while the second context information may be composed of stopwords whose meanings cannot be inferred. The stopwords may refer to strings that do not have significant meaning for sentence analysis.

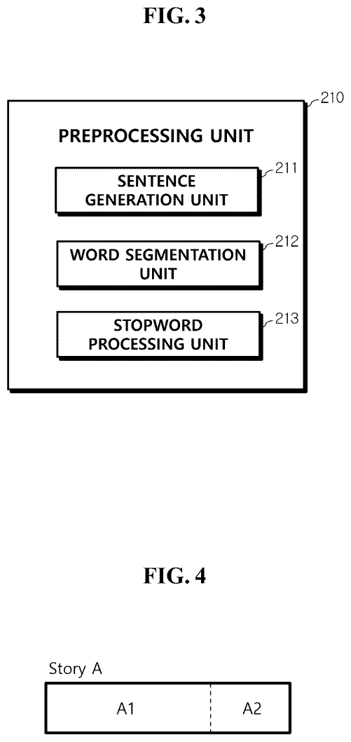

FIG. 3 is a block diagram illustrating a configuration of a preprocessing unit according to one embodiment, and FIG. 4 is a diagram illustrating first context information and second context information extracted according to one embodiment.

Referring to FIG. 3, the preprocessing unit 210 may include a sentence generation unit 211, a word segmentation unit 212, and a stopword processing unit 213. The sentence generation unit 211, the word segmentation unit 212, and the stopword processing unit 213 may each be configured as separate hardware components, but the sentence generation unit 211, the word segmentation unit 212, and the stopword processing unit 213 of the present disclosure are not limited to this, and may be configured as separate software components on a single hardware component.

The sentence generation unit 211 may receive the entire essay text data, distinguish the entire text data into sentences, and output the distinguished data. The word segmentation unit 212 may segment words from the distinguished sentences and output the segmented words. The sentence generation unit 211 and the word segmentation unit 212 may step-by-step perform a series of processes to segment and extract words from the input essay text data.

Referring to FIGS. 3 and 4, the stopword processing unit 213 may determine whether the segmented word is a stopword. According to one embodiment, the memory 110 may include a stopword database, and the stopword processing unit 213 may process the segmented word as a stopword when the segmented word matches a word included in the stopword database. The stopword processing unit 213 may classify words determined to be stopwords as second context information A2, and may classify words determined not to be stopwords as first context information A1. However, the stopword processing unit 213 of the present disclosure may extract the first context information A1 and the second context information A2 through any method of distinguishing between a word whose meaning is identified and a stopword.

The preprocessing unit 210 may output the first context information A1 and second context information A2 for each analysis element of the essay. Specifically, the analysis elements of the essay may be sentence characteristics that are interpreted for each sentence, and for example, may be characteristics that are identified depending on whether the sentence represents the speaker's character, an event, or a conflict relationship.

According to one embodiment, the preprocessing unit 210 may distinguish and output words for each sentence from the entire essay text data, and analyze the characteristics of the words by comparing words included in a specific sentence with a word database pre-stored in the memory 110. For example, the memory 110 may separately store words that represent the speaker's character in a first database, words that represent events in a second database, and words that represent a conflict relationship in a third database, and the preprocessing unit 210 may determine whether any words included in the specific sentence are present in the word database stored in the memory 110. When the word included in the specific sentence is the same as the word included in the first database, the preprocessing unit 210 may classify the corresponding sentence as the sentence representing the speaker's character.

According to another embodiment, the sentence generation unit 211 may output the entire essay text by distinguishing the entire essay text for each sentence, and the preprocessing unit 210 may acquire the analysis elements of the sentence by inputting the sentence into a pre-trained analysis element classification model. The preprocessing unit 210 may group the sentences for each analysis element and classify each group as the first context information A1 or the second context information A2 in units of groups. For example, the preprocessing unit 210 may classify the sentences as a first sentence group consisting of sentences representing the speaker's character, a second sentence group consisting of sentences representing an event, and a third sentence group consisting of sentences representing a conflict relationship. The preprocessing unit 210 may classify each of the first sentence group, the second sentence group, and the third sentence group as the first context information A1 or the second context information A2.

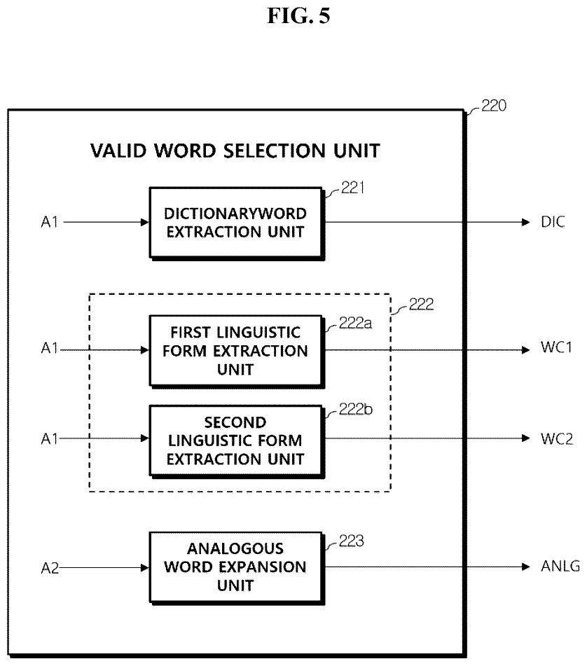

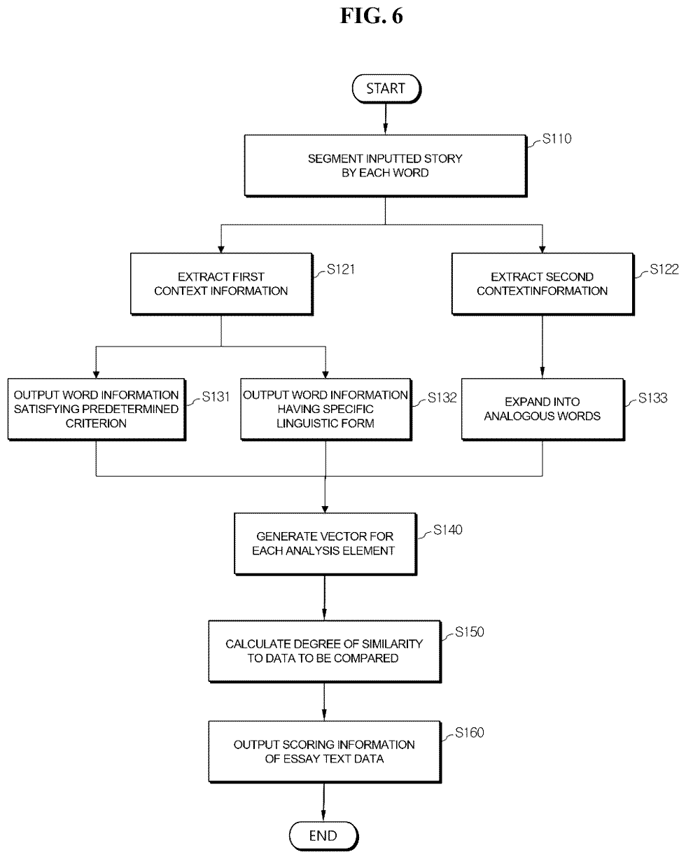

FIG. 5 is a block diagram illustrating the valid word selection unit 220 and input/output data according to one embodiment.

Referring to FIG. 5, the valid word selection unit 220 may include a dictionary word extraction unit 221, a linguistic form extraction unit 222, and an analogous word expansion unit 223, and the linguistic form extraction unit 222 may include a first linguistic form extraction unit 222a and a second linguistic form extraction unit 222b that are classified according to the type of linguistic form. The first context information A1 generated in the preprocessing unit 210 may be input to the dictionary word extraction unit 221 and the linguistic form extraction unit 222, and the second context information A2 may be input to the analogous word expansion unit 223.

The dictionary word extraction unit 221 may extract word information satisfying a predetermined criterion from the first context information A1. The predetermined criterion may be whether the input first context information A1 is word information defined in a dictionary. According to one embodiment, the dictionary word extraction unit 221 may be composed of an artificial intelligence model trained to infer whether the input word information is the word defined in the dictionary. In this case, the artificial intelligence model may compare each word included in a pre-stored lexicon with the first context information A1, and output the word of the first context information A1 corresponding to the word included in the lexicon as dictionary word information DIC. For example, the dictionary word information DIC may be the number of words.

The linguistic form extraction unit 222 may include the first linguistic form extraction unit 222a that extracts first linguistic form word information WC1 from the first context information A1, and the second linguistic form extraction unit 222b that extracts second linguistic form word information WC2 from the first context information A1. For example, the first linguistic form extraction unit 222a may extract adjective word information, and the second linguistic form extraction unit 222b may extract noun word information.

According to one embodiment, the linguistic form extraction unit 222 may be composed of an artificial intelligence model trained to infer whether the input word information is word information having a specific linguistic form. As an example, the first linguistic form extraction unit 222a that infers adjective word information may be composed of an artificial intelligence model with higher inference accuracy but lower inference speed than the second linguistic form extraction unit 222b, and the second linguistic form extraction unit 222b that infers noun word information may be composed of an artificial intelligence model with low inference accuracy but high inference speed. According to one embodiment, the second linguistic form inference model may generate the original form of the corresponding word, compare the original word of the word with the word in the input story, and convert the original form of the word back to the original word. However, the present disclosure is not limited thereto, and the first linguistic form extraction unit 222a may have lower inference accuracy and higher inference speed than the second linguistic form extraction unit 222b.

The inference speed and inference accuracy of the linguistic form extraction unit 222 of the present disclosure are not limited to this, and an artificial intelligence model corresponding to the linguistic form may be adaptively selected and applied to inference. Accordingly, the electronic device 1 of the present disclosure may flexibly infer the linguistic form of word information by setting the linguistic form to be accurately inferred and the linguistic form to be inferred quickly according to user settings.

The first linguistic form extraction unit 222a may output word information corresponding to a first linguistic form among the input first context information A1 as first linguistic form word information WC1, and the second linguistic form extraction unit 222b may extract word information corresponding to a second linguistic form among the input first context information A1 as second linguistic form word information WC2.

The second context information A2 is a group of stopwords whose meanings cannot be identified by the preprocessing unit 210, and the analogous word expansion unit 223 may perform analogous word expansion on the input second context information A2.

According to one embodiment, the analogous word expansion unit 223 does not vectorize the words of the second context information A2 by indexing each word in order, but may vectorize so that analogous words have vectors with similar direction and force, thereby searching for analogous words in the second context information A2 based on a trained artificial intelligence. In other words, the analogous word expansion unit 223 may search for words that have analogous meanings and are expressed by similar vectors.

According to one embodiment, the analogous word expansion unit 223 may be composed of an artificial intelligence model trained to infer analogous word information ANLG for input word information. For example, the artificial intelligence model may be an artificial intelligence model trained based on Gensim.

The analogous word expansion unit 223 may output analogous word information ANLG as a result of analogous word inference for the second context information A2, and the analogous word information ANLG may be the number of substituted words for the second context information A2 and may be analogous word text information for the second context information A2.

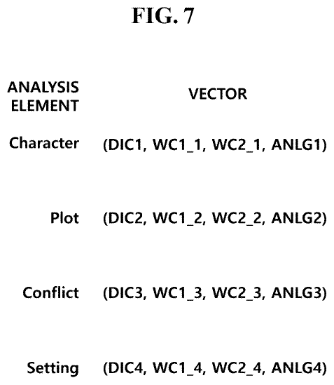

FIG. 6 is a flowchart illustrating a method of scoring an input story according to one embodiment of the present invention, and FIG. 7 is a diagram illustrating vectors generated for each analysis element according to one embodiment.

Referring to FIG. 6, the electronic device 1 may extract first context information and second context information from an input story, output word information satisfying a predetermined criterion and word information having a specific linguistic form from first context information, and perform analogous word expansion from second context information. The electronic device 1 may generate a vector for each analysis element, calculate the level of similarity between data to be compared and the vector, and output scoring information of essay text data based on the similarity.

In operation S110, the electronic device 1 may segment an input story by each word. According to one embodiment, the electronic device 1 may perform grouping for each analysis element to segment the corresponding words. For example, the electronic device 1 may classify sentences as a first sentence group consisting of sentences representing the speaker's character, a second sentence group consisting of sentences representing an event, and a third sentence group consisting of sentences representing a conflict relationship based on an analysis element classification model. The electronic device 1 may segment word information by grouping the word information into the first sentence group, the second sentence group, and the third sentence group.

In operations S121 and S122, the electronic device 1 may extract first context information and second context information from the segmented words. According to one embodiment, the electronic device 1 may classify words determined to be stopwords as the second context information, and classify the remaining words, which are not classified as the second context information, as the first context information.

In operations in S131 and S132, the electronic device 1 may output word information satisfying a predetermined criterion from the first context information, and output word information having a specific linguistic form. At this time, the output information may be dictionary word information DIC indicating the number of words defined in advance among the first context information, and may be word information having a specific linguistic form which is classified as a specific linguistic form.

In operation S133, the electronic device 1 may perform analogous word expansion from the second context information classified as a stopword. According to one embodiment, the electronic device 1 may search for analogous words of the words of the second context information based on a vector, and output the analogous word search result as analogous word information ANLG.

The electronic device 1 may perform operations S131 to S133 simultaneously after outputting the first context information and the second context information, and perform operations S131 to S133 in parallel by processors 20 composed of a plurality of hardware components.

According to one embodiment, the electronic device 1 may perform operations S131 to S133 for each group divided for each analysis element in operation S110. For example, the electronic device 1 may classify and store output values of operations S131 to S133 for words classified as a first analysis element and output values of operations S131 to S133 for words classified as a second analysis element.

In operation S140, the electronic device 1 may generate a vector for each analysis element from the output values output in operations S131 to S133.

Referring to FIG. 7, the analysis elements for essay text data may be divided into “Character,” “Plot,” “Conflict,” and “Setting,” and the electronic device 1 may classify the essay text data for each analysis element. The electronic device 1 may output a first analysis element vector in which first dictionary word information DIC1, 1_1 linguistic form word information WC1_1, 2_1 linguistic form word information WC2_1, and first analogous word information ANLG1 are generated from the first context information and the second context information corresponding to the “Character” analysis element and are used as vector elements, and output a second analysis element vector in which second dictionary word information DIC2, 1_2 linguistic form word information WC1_2, 2_2 linguistic form word information WC2_2, and second analogous word information ANLG2 are generated from the first context information and the second context information corresponding to the “Plot” analysis element and are used as vector elements. In a similar way, the electronic device 1 may output a third analysis element vector in which third dictionary word information DIC3, 1_3 linguistic form word information WC1_3, 2_3 linguistic form word information WC2_3, and third analogous word information ANLG3 are generated from the first context information and the second context information corresponding to the “Conflict” analysis element and are used as vector elements, and output a fourth analysis element vector in which fourth dictionary word information DIC4, 1_4 linguistic form word information WC1_4, 2_4 linguistic form word information WC2_4, and fourth analogous word information ANLG4 are generated from the first context information and the second context information corresponding to the “Setting” analysis element and are used as vector elements.

In operation S150, the electronic device 1 may calculate the level of similarity between the vector generated in operation S140 and data to be compared. The data to be compared may be vector information extracted for each analysis element from an essay evaluated as being well-created. For example, the data to be compared may be composed of the first analysis element vector to the fourth analysis element vector.

Specifically, the electronic device 1 may calculate the level of similarity between the data to be compared and a vector generated from the essay text data for each analysis element. For example, the electronic device 1 may calculate an absolute value of a difference between the first analysis element vector generated in operation S140 and the first analysis element vector of the data to be compared, as the similarity in the first analysis element vector. In a similar way, the electronic device 1 may calculate an absolute value of a vector difference in the second analysis element vector as the similarity of the second analysis element vector, and an absolute value of a vector difference in the third analysis element vector as the similarity of the third analysis element vector. That is, the electronic device 1 may compare the distribution of the number of words of the data to be compared and the distribution of the output values.

According to another embodiment, the electronic device 1 may compare the distribution of the number of words for each position of the essay text data and the data to be compared. Specifically, the electronic device 1 may generate dictionary word information, linguistic form word information, and analogous word information for each position of the entire essay, and compare the distribution of the dictionary word information, linguistic form word information, and analogous word information with the distribution of the number of words stored in advance for each position of the essay.

In operation S160, the electronic device 1 may output scoring information of the essay text data based on the level of similarity with the data to be compared. When the similarity is higher than a reference similarity, the electronic device 1 may output scoring information meaning “pass,” and when the similarity is lower than the reference similarity, the electronic device 1 may output scoring information meaning “fail.”

According to one embodiment, the electronic device 1 may output the scoring information for each analysis element. For example, when the similarity of the first analysis element is higher than the reference similarity, the electronic device 1 may output the scoring information meaning “pass,” and when the similarity of the second analysis element is lower than the reference similarity, the electronic device 1 may output the scoring information meaning “fail.”

Since the electronic device 1 of the present disclosure generates scoring information for each analysis element, an essay writer who receives the scoring information may easily identify parts that need to be supplemented in the created essay. For example, when the analysis elements are divided into sentences representing the speaker's character, sentences representing an event, and sentences representing a conflict relationship, the electronic device 1 may provide information on which part of the essay needs to be supplemented.

Meanwhile, one or more embodiments may be implemented together as long as the various embodiments described above do not conflict with each other.

Meanwhile, the various embodiments described above may be implemented in a recording medium that can be read by a computer or a similar device using software, hardware, or a combination thereof.

In terms of hardware implementation, the embodiments described in the present disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and other electrical units for performing functions.

In some cases, the embodiments described in this specification may be implemented by the processor itself. According to software implementation, the embodiments, such as the procedures and functions described in this specification, may be implemented by separate software modules. Each of the software modules described above may perform one or more functions and operations described in this specification.

Meanwhile, computer instructions for performing processing operations of a server or terminal according to various embodiments of the present disclosure described above may be stored in a non-transitory computer-readable medium. The computer instructions stored on the non-transitory computer-readable medium, when executed by a processor of a particular device, may cause the device to perform the processing operations of the electronic device according to various embodiments described above.

The non-transitory readable medium is not a medium that stores data for a short period of time, such as a register, cache, or memory, but a medium that stores data semi-permanently and can be read by a device. Specifically, the various applications or programs described above may be stored and provided on the non-transitory readable medium, such as a compact disc (CD), a digital versatile disc (DVD), a hard disk, a Blu-ray disk, a USB, a memory card, or a ROM.

Exemplary embodiments of the present invention have been illustrated and described above, but the present invention is not limited to the above-described specific exemplary embodiments, it is obvious that various modifications may be made by those skilled in the art, to which the present invention pertains without departing from the gist of the present invention, which is claimed in the claims, and such modifications should not be individually understood from the technical spirit or prospect of the present invention.

### INDUSTRIAL APPLICABILITY

The electronic device according to the embodiment of the present disclosure can segment an input story by each word and generate a score of an essay based on the distribution of words satisfying a predetermined criterion, words having a specific linguistic form, and analogous words. Accordingly, the electronic device of the present invention can be used to analyze an essay with high reliability by comparing data to be compared, which is evaluated as an excellent essay, with an essay created by the user.

1. An electronic device that performs a scoring method based on essay text data, the electronic device comprising:
a preprocessing unit configured to segment an input story by each word and, according to a word meaning inference possibility, distinguish first context information and second context information and output the distinguished information;
a valid word selection unit configured to extract, from the first context information, word information satisfying a predetermined criterion, extract, from the first context information, word information having a specific linguistic form, and carry out analogous word expansion for the second context information; and
a scoring unit configured to receive output values of the valid word selection unit for each analysis element of essay text data, and calculate a degree of similarity between data to be compared and the output values to output scoring information of the essay text data.

2. The electronic device of claim 1, wherein the valid word selection unit extracts adjective word information from the first context information based on a first linguistic form inference model, and extracts noun word information based on a second linguistic form inference model which has a higher inference speed but lower accuracy than the first linguistic form inference model.

3. The electronic device of claim 2, wherein the second linguistic form inference model generates an original form of a word, compares a word in the input story with the original form of the word, and converts the original form of the word back to an original word.

4. The electronic device of claim 2, wherein the valid word selection unit outputs dictionary-defined word information in the first context information as the word information satisfying the predetermined criterion.

5. The electronic device of claim 1, wherein the output values are information obtained by vectorizing, for each of the analysis elements, the word information satisfying the predetermined criterion, the word information having the specific linguistic form, and analogous word expansion result information.

6. The electronic device of claim 1, wherein the scoring unit compares distribution of the number of words in the data to be compared and distribution of the output values.

7. The electronic device of claim 6, wherein the scoring unit compares distribution of the number of all words in the data to be compared and the output values, or compares distribution of the number of words for each position in the data to be compared and the essay text data.
